(19) United States
(12) Patent Application Publication
(10) Pub. No.: US 2026/0264490 A1
(43) Pub. Date: Sep. 10, 2026

(54) Clamp Assembly for Deployable Curtain

(71) Applicant: Aero Industries, Inc., Indianapolis, IN (US)

(72) Inventors: James Tuerk, Indianapolis, IN (US); Ronald Eggers, Fremont, NE (US); Justin Kruer, Franklin, IN (US); Jacob Lashbrooks, Greenwood, IN (US); Robert C. McKibben, Lebanon, IN (US); Aaron M. Mosier, Mooresville, IN (US); Matt Hayes, Indianapolis, IN (US)

(21) Appl. No.: 19/073,766

(22) Filed: Mar. 7, 2025

(51) Int. Cl. B60J 7/06; B62D 35/00

(52) U.S. Cl. CPC B60J 7/062; B62D 35/001

(57) ABSTRACT

An improvement is provided for a rolling tarp system that includes a rear sliding frame with a rear curtain closing the access opening of the rear frame. A clamp assembly clamps the sides of the curtain when the curtain is in its closed position. The clamp assembly includes a clamping component with a hinged element that includes seal elements configured to clamp onto the side edge of the curtain when the hinged element is in its closed configuration. The clamp assembly further includes a locking component that locks the clamping component in the closed configuration by way of a spring-biased bolt element engaged within an opening in a hasp plate affixed to the tarp system. The hasp plate includes a contact plate that pushes the bolt element upward as the locking component is moved to the locked position with the clamping component in its closed configuration.

### BACKGROUND

This disclosure relates to deployable curtains for trailer cover systems. Flatbed trailers are still the predominant method for transporting goods. In one form, the deck of the trailer is covered by a rigid box structure. In another form, the deck is covered by a rolling tarpaulin system. The rolling tarp can be moved to a stowed position at the front or back end of the trailer to expose the deck of the flatbed, which allows for goods to be loaded and unloaded by forklift or crane. In the rolling tarp system. at least one end of the trailer has an opening for loading and unloading goods from the deck of the trailer. The opening typically includes a closure of some sort—whether hinged outswing doors or a flexible curtain.

The CONESTOGA® of Aero Industries, Inc., is one example of a rolling tarp system. As shown in FIG. 1, a trailer T includes a rolling cover system 10 supported on the deck D of the trailer. The cover system includes a plurality of U-shaped bow assemblies 12 that are supported by rolling carriages 13 that roll on side rails 15 affixed to the deck D. The bow assemblies support a flexible tarpaulin that is sized to span and cover the length of the trailer T when the rolling tarp system is in its deployed configuration. In a stowed or retracted configuration, the tarpaulin folds or buckles as the bow assemblies are moved to the one end of the trailer. The rolling tarp system 10 includes a front bulkhead assembly 20 that is typically fixed in position and includes a rigid structure for protecting the interior of the rolling tarp system from the elements. The system also includes a rear frame assembly 22 that includes rolling carriages 23 that can move with the bow assemblies 12 to expose a substantially length of the deck D. The rear frame includes features for locking the frame assembly 22 to the deck in the fully deployed configuration of the cover system.

As shown in FIG. 2, the rear frame assembly 22 includes a frame structure 25 that defines the opening 26 for loading and unloading goods from the trailer when the cover system is deployed. The opening is provided with a closure in the form of a flexible rear curtain 30. The rear curtain is typically formed of the same material as the tarpaulin supported by the bow assemblies. The rear curtain is configured to be pulled upward to fold or buckle into a compressed configuration at the top of the frame 25. The curtain can be provided with a laterally extending stiffener 32 at the lower portion of the curtain and, in some cases, lateral stiffeners at one or more intermediate positions on the curtain. The stiffeners hold the curtain in its closed configuration and prevent billowing of the curtain as the trailer travels at highway speeds.

The lower portion of the curtain includes a locking structure to lock the curtain to the deck D of the trailer. In addition to the lock and lateral stiffeners, it is desirable to clamp the side edges 30a to the frame 25 in some manner to hold the curtain in a stable closed configuration.

### SUMMARY OF THE DISCLOSURE

An improvement is provided for a rolling tarp system, in which the tarp system includes a rear sliding frame with a rear curtain closing the access opening of the rear frame. The improvement includes a clamp assembly for clamping the sides of the curtain when the curtain is in its deployed or closed position. The clamp assembly includes a clamping component with a hinged element that includes seal elements configured to clamp onto the side edge of the curtain when the hinged element is in its closed configuration.

The clamp assembly further includes a locking component that locks the clamping component in the closed configuration by way of a bolt element engaged within an opening in a hasp plate affixed to the tarp system. The locking component includes a handle for moving a spring biased vertical post of the bolt element up to free the bolt element from the hasp plate opening. The hasp plate includes an angled contact plate that is operable to push the vertical post of the bolt element upward as the locking component is moved from an open or unlocked position to the locked position with the clamping component in its closed configuration.

In another feature, the rear curtain is a sectionalized construction in which multiple panels are vertically connected to form the rear curtain. The panels are connected by a horizontal keder having a pair of parallel slotted channels configured to receive a transverse bead formed along a horizontal edge of the panel. The horizontal keders serve as lateral stiffeners. One of the horizontal keders is at the lower portion of the curtain to connect a hidden vent panel. This particular keder includes an exposed face that is engaged by one of the seal elements of the clamp assembly. Other horizontal keders are located at middle portions of the rear curtain and are configured to be hidden behind the curtain so that the outward face of the curtain is not interrupted. The horizontal keders allow for differently dimensioned panels to be connected to form rear curtains of different heights. The panels can also be readily replaced.

### DESCRIPTION OF THE DRAWINGS

FIG. 1 is a perspective view of a trailer with a rolling cover system and rear curtain.

FIG. 2 is a perspective view of a rear frame and curtain for the rolling cover system of FIG. 1.

FIGS. 3A-3B are enlarged rear perspective and end views of a clamp assembly according to the present disclosure, shown in a first locked position for clamping the rear curtain shown in FIGS. 1-2.

FIG. 3B is an end view of the clamp assembly shown in FIG. 3A.

FIG. 4 is an exploded view of the components of the clamp assembly shown in FIGS. 3A-3B.

FIGS. 5A-5D are perspective, top, side and end views of the clamp assembly shown in FIGS. 3A-3B.

FIG. 6 is a perspective view of a hasp for the clamp assembly shown in FIGS. 3A-3B.

FIGS. 7A-7B are perspective and end views of the clamp assembly of FIGS. 3A-3B shown in a second unlocked position.

FIG. 8A-8B are perspective and end views of the clamp assembly of FIGS. 3A-3B shown in a third open position

FIG. 9A-9B are perspective and end views of the clamp assembly of FIGS. 3A-3B shown in a fourth position of the clamp assembly moving from the open position to the locked position.

FIG. 10 is a perspective view of a locking component extrusion and hinge element of the clamp assembly of FIGS. 3A-3B.

FIG. 11 is an exploded view of the locking component extrusion and hinge element shown in FIG. 10.

FIG. 12 is a top view of the locking component extrusion and hinge element shown in FIG. 10.

FIGS. 13A-13B are top perspective cut-away views of the locking component extrusion and hinge element shown in FIG. 10, shown in a clamping and an open position.

FIG. 14A is a view of the outward face of a rear curtain for the rolling cover system that is engaged by the clamp assembly disclosed herein.

FIG. 14B is a view of the interior face of the rear curtain of FIG. 14A, as viewed from the interior of the rolling cover system.

FIG. 15 is a perspective view of an intermediate keder for use in connecting two panels of the rear curtain shown in FIGS. 14A-14B.

FIG. 16 is a perspective view of a lower keder for use in connecting a panel of the rear curtain to a hidden vent panel at a lower portion of the rear curtain.

FIG. 17A is a perspective view of the operating end of a tool for rolling up the rear cover arranged for engagement with the lower keder shown in FIG. 16.

FIG. 17B is a perspective view of the operating end of the tool engaged in the lower keder.

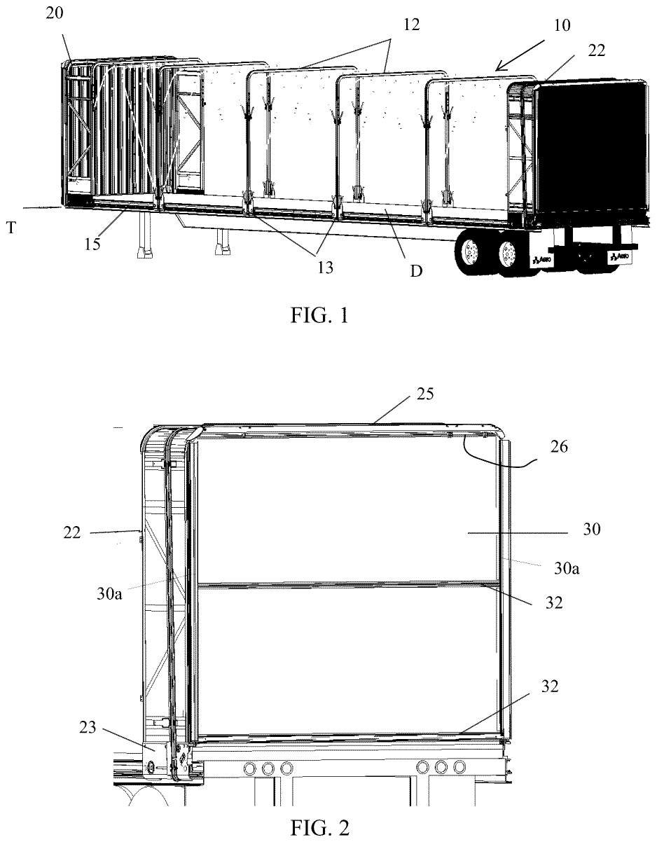

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

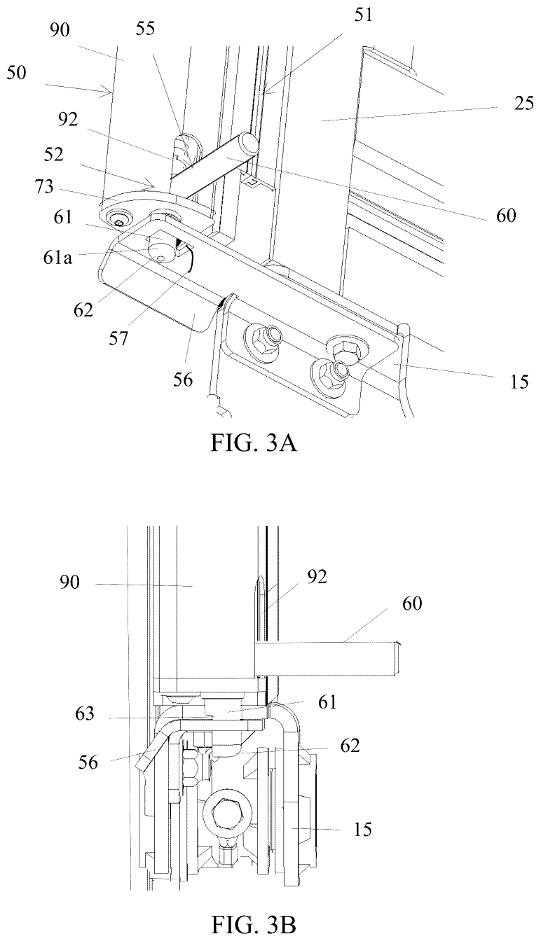

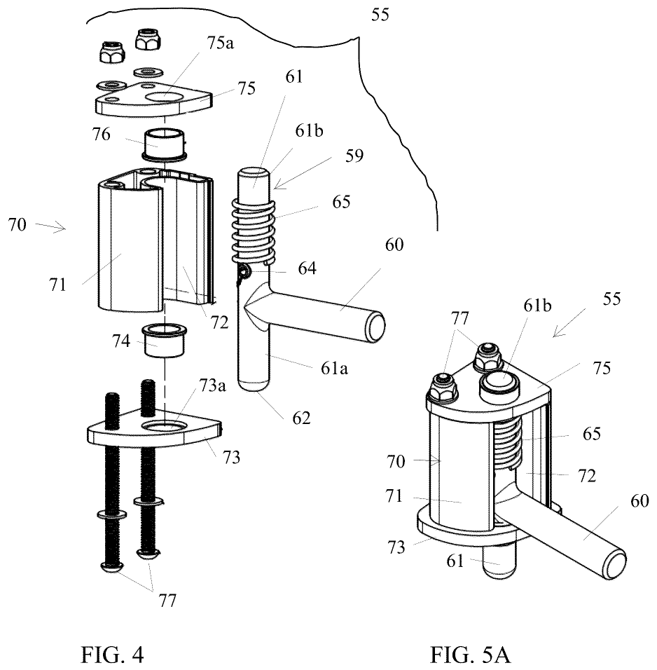

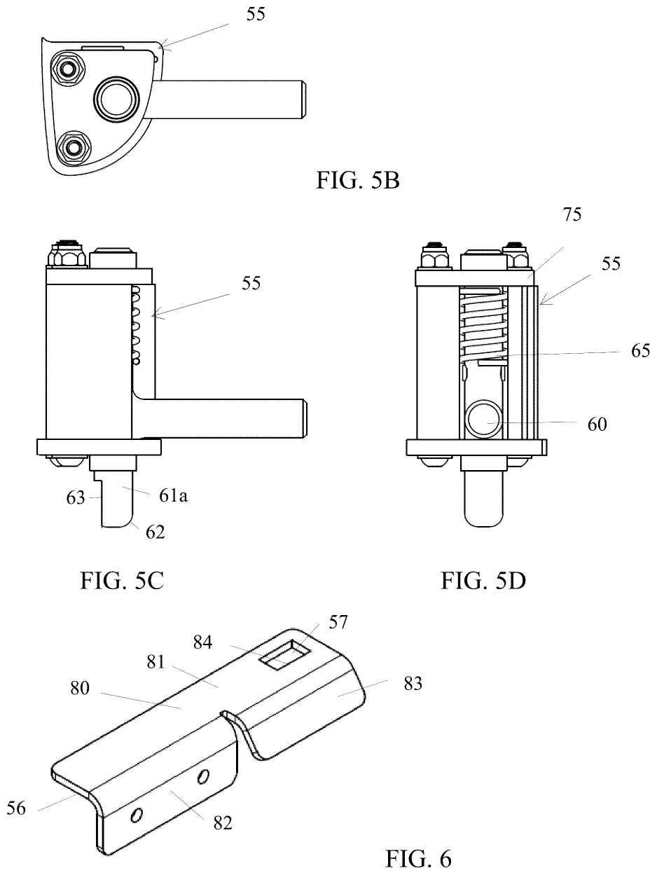

According to the present disclosure, the sides of the curtain 30 are clamped by a clamp assembly 50, shown in FIGS. 3A-3B, provided on each side of the opening 26 of the rear frame 25. The clamp assembly 50 includes a clamping component 51 and a locking component 52 that locks the clamping component in engagement with the side of the curtain. In general, the locking component 52 includes a bolt assembly 55 that includes a bolt element 59 configured to extend through an opening 57 in a hasp 56 that is fastened to the rear frame assembly 22, the side rail 15 or the deck D of the trailer T. As shown in the detail views of FIGS. 4-5D, the bolt element 59 of the bolt assembly 55 includes a vertical post 61 with an elongated handle 61 projecting perpendicularly or radially outward from the post. The handle is sized and arranged to be manually grasped to raise and lower the bolt element relative to a bolt housing 70 and locking component extrusion 90 (described in more detail herein). In one embodiment, the handle can be about 3 inches long with a diameter of 0.625 inches. The handle bisects the vertical post 61 into a lower portion 61a and an upper portion 61b. The lower portion terminates in a rounded tip 62 that slides against the hasp 56 until the lower portion 61a reaches the opening 57 in the hasp. As shown in more detail in FIG. 5C, the lower portion 61a of the vertical post 61 includes a notch 63 that defines a generally planar surface. The notch 63 is configured to engage an edge 84 of the opening 57 (FIG. 6) in the hasp when the lower portion 61a projects through the opening, as shown in FIGS. 3A-3B. The bolt element includes a set screw or other projection 64 projecting from the upper portion 61b of the vertical post. The projection 64 supports a compression spring 65 concentrically disposed on the upper portion.

The bolt assembly 55 includes a bolt housing 70 that retains the bolt element 59 and allows the bolt element to be manually moved up by way of a horizontal post or handle 60 and also allows the bolt assembly to be automatically moved down by way of the compression spring 65. The bolt housing 70 includes a main body 71 that defines a generally U-shaped channel 72 that is sized to receive the vertical post 61 of the boil element. The main body 71 can be in the form of a hollow aluminum extrusion to reduce the weight of the bolt housing. The ends of the channel 72 are capped by a lower cap 73 and an upper cap 75. Each cap defines a respective bore 73a, 75a to receive a respective bushing 74, 76. The bushings 74, 76 are configured to slidably receive the respective lower portion 61a and upper portion 61b of the bolt post 61. The bushings can be flanged bronze bearings, nylon or other polymer, or other similar construction that provides a low-friction surface for the rotation and vertical movement of the bolt post 61. Fasteners 77 extend through the main body 71 and fix the caps 73, 75 to the ends of the main body to hold the bolt element 59 within the U-shaped channel 72. Moreover, the upper cap 75 captures the compression spring 65 between the projection 64 and the underside of the upper cap 75. The spring 65 resists upward movement of the bolt element 59 when a user manually moves the bolt handle 60 upward. More importantly, the spring 65 automatically pushes the bolt element downward so that the lower portion 61a of the bolt post will automatically extend into the opening 57 of the hasp 56 when the bolt element is aligned with the opening.

The hasp 56 includes a hasp plate 80 that includes a top plate 81, which defines the opening 57, with a mounting portion 82 and an angled contact plate 83 extending from the top plate. The mounting portion 82 is configured to be fastened to the trailer deck D, side rails 15, rear frame 25 or other structure fixed to the trailer or to rear frame assembly 22. The angled contact plate 83 is angled downward relative to the top plate 81 that defines the opening 57. As shown in FIGS. 9A-9B, the angled contact plate 83 is arranged to contact the rounded tip 62 of the bolt element 59. The opening 57 can be rectangular, forming the linear edge 84 of the opening 57. The width of the rectangular opening, as measured from the edge 84, is slightly greater than the depth of the rounded tip 62 of the post 61 as truncated by the notch 63. In other words, the rounded tip 62 has a close fit within the short width of the opening 57. In one embodiment, the width is about 0.563 inches, while the rounded tip has a depth dimension of 0.500 inches at the notch. The notch can have a height of about 0.750 inches. The rectangular opening 57 has a length that is greater than the effective diameter of the rounded tip 62 to account for a greater degree of play between the bolt element 59 and the hasp 56. In one embodiment, the rectangular opening 57 has a length of 1.00 inches, while the rounded tip 62 has a width of 0.625 inches, providing 0.375 inches of play. In other embodiments, the opening 57 can be circular, oval or with a cross-section similar to the cross-section of the post 61 to provide a closer fit between the opening and the post. In addition, the notch 63 can be eliminated in the rounded tip 62 so that the tip has a circular cross-section along its length. It can be appreciated that with these modifications the interface between the post 61 and the hasp opening 57 requires a tighter tolerance to ensure that the post can be consistently received within the opening.

In one aspect of the locking component, an angled contact interface is provided between the top 62 of the post 61 and the hasp plate 80 the to facilitate movement of the post into engagement with the hasp opening 57 during movement of the locking component to its locked position. In the embodiment described above, the angled contact interface is achieved by the angled contact plate 83 of the hasp plate. In other embodiments, the leading contact face of the tip 62 of the post 61 can be angled to slide against the contact plate 83. With this embodiment, the angled contact plate 83 can be eliminated since the angled contact face of the modified tip can slide along the edge of the top plate 81 of the hasp.

The operation of the clamp assembly 50 is depicted in FIGS. 3A-3B and 7A-9B. The locking component 52 is in its locked position in FIGS. 3A-3B in which the post 61 extends through the opening 57 in the hasp 56. It is understood that the spring 65 (not seen in FIGS. 3A-3B) pushes the bolt element 59 down so that the handle 60 contacts the lower cap 73. The bolt housing 70 is positioned sufficiently close to the hasp for the lower portion 61a of the bolt post to extend into the hasp opening 57. In this configuration, the clamping component 51 is clamped onto the side of the rear curtain 30 (not shown in the figures for clarity). As described in more detail herein, the clamping component 51 extends along a substantial portion of the extended height of the rear curtain to provide a stabilizing clamping force for the curtain.

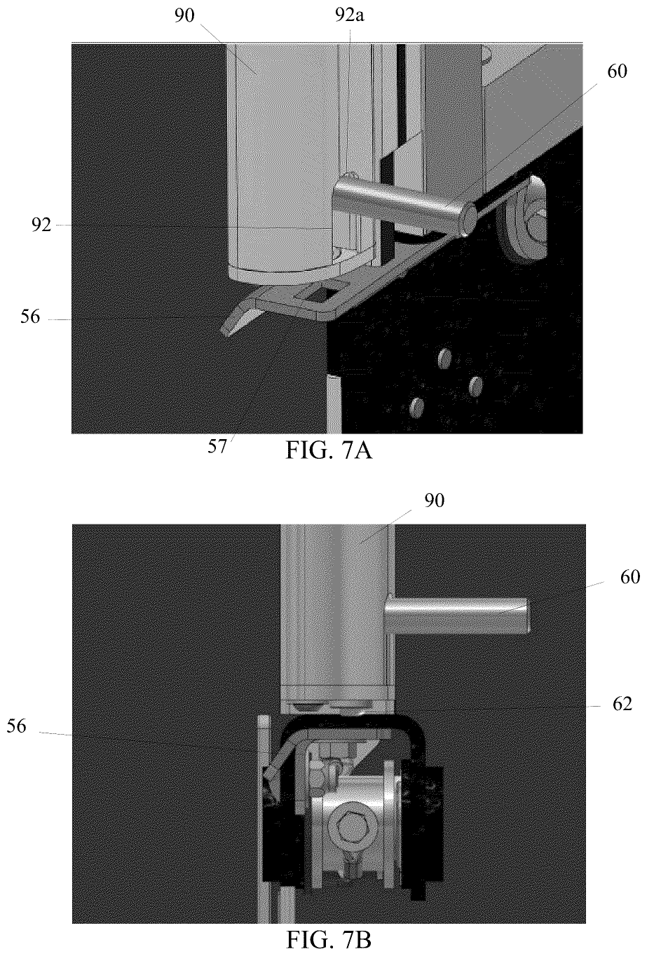

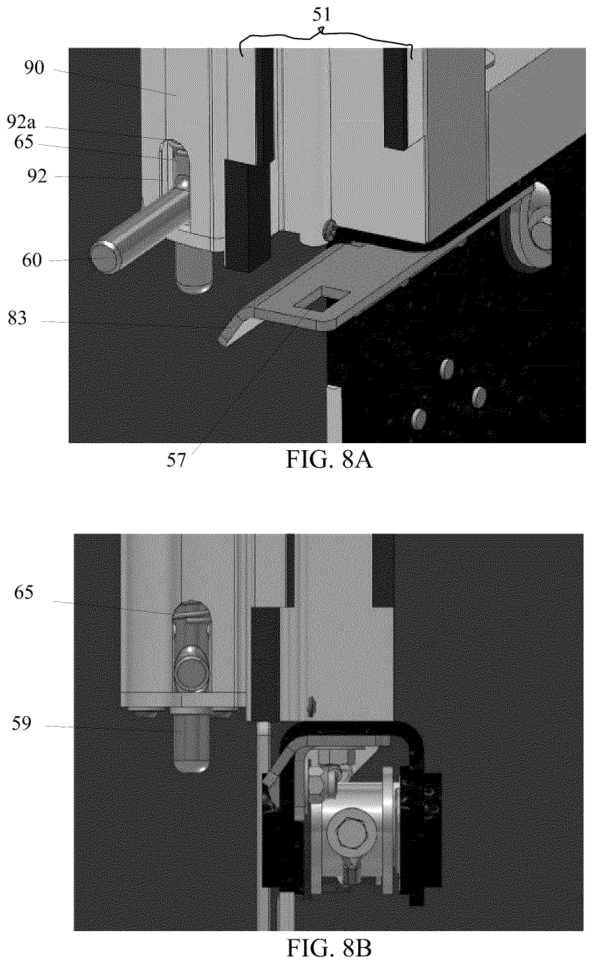

When it is desired to unlock the clamping component 51 from the rear curtain 30, the handle 60 is manually lifted upward within the locking component extrusion 90, as shown in FIGS. 7A-7B. It is noted that the extrusion defines a U-shaped opening 92 through which the handle 60 extends when the bolt housing 70 is mounted within the extrusion (as described in more detail herein). The handle 60 can be pulled upward until the handle contacts the top end 92a of the opening 92. Alternatively, the handle can be pulled upward to fully compress the spring 65. In either case, the handle is pulled upward to raise the bolt post 61 a sufficient distance so that the rounded tip 62 exits the opening 57 of the hasp, as shown in FIGS. 7A-7B.

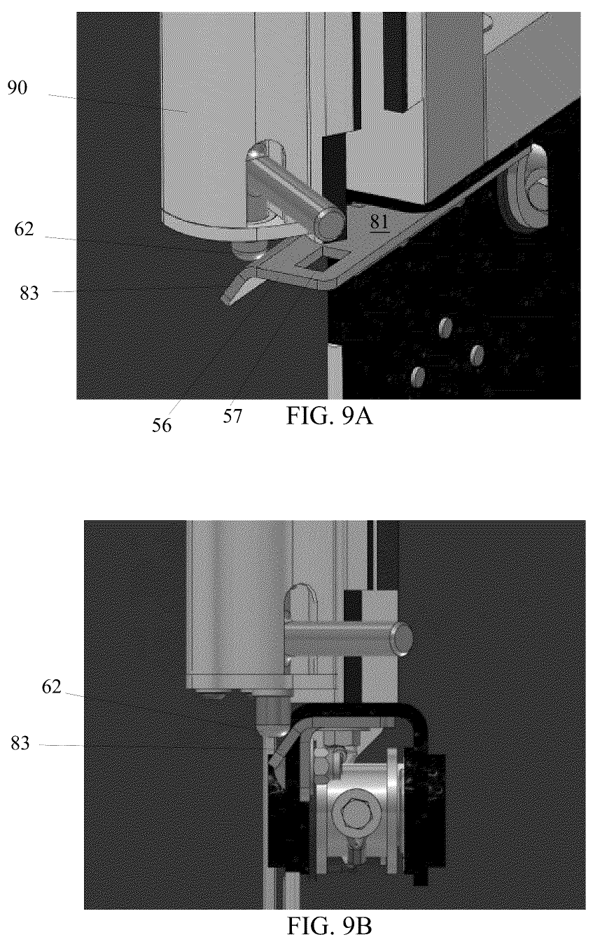

With the bolt element free of the hasp, the locking component extrusion 90 is free to pivot by way of the hinge element 95 (described in more detail herein), until the extrusion 90 is clear of the hasp 56, as shown in FIGS. 8A-8B. More importantly, the clamping component 51 is opened to release the clamping pressure on the rear curtain. It can be appreciated that the spring 65 pushes the bolt element 59 down until the handle bears against the lower cap 73. The rear curtain can be rolled up for access through the opening 26 of the rear frame.

The clamping assembly 50 can be closed with the curtain rolled up, or with the curtain rolled down, by manually pushing the locking component extrusion 90 back toward the curtain, as shown in FIGS. 9A-9B. As the extrusion 90 pivots, the rounded tip 62 of the bolt element 59 contacts the angled contact plate 83 of the hasp plate 80. Continued pivoting of the extrusion causes the rounded tip to ride up the angled contact plate 83 of the hasp plate, which pushes the bolt post 61 upward against the force of the compression spring 65. This movement continues until the tip 62 reaches the top plate 81 of the hasp, then the rounded tip slides across the top surface until the post 61 is aligned with the hasp opening 57, at which point the spring pushes the lower portion 61a of the post into the hasp opening.

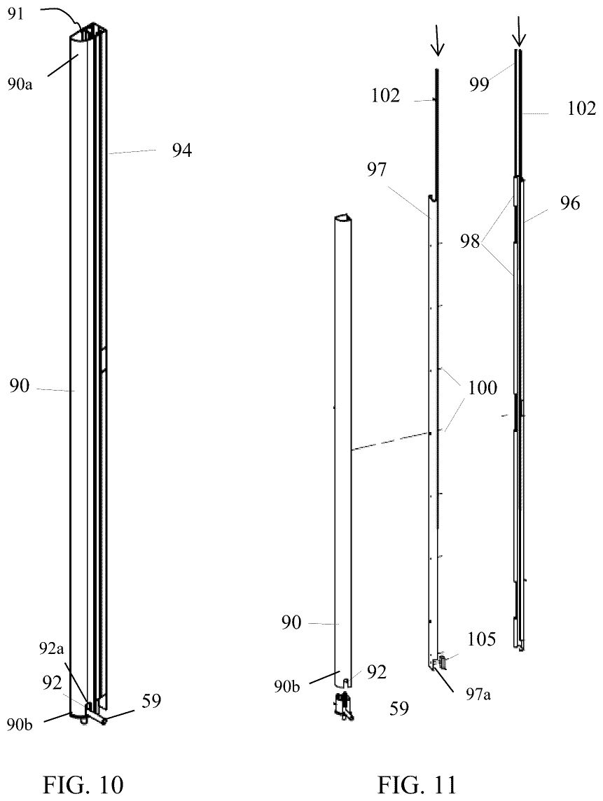

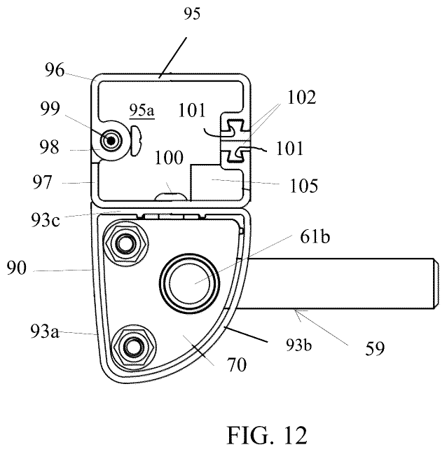

As noted above, the clamp assembly 50 includes a locking component extrusion 90 that contains the bolt assembly 55 and that is connected to a hinge element 95, which incorporates the clamping component 51. Details of the locking component extrusion 90 and hinge element 95 are shown in FIGS. 10-13B. The locking component extrusion 90 defines a bore 91 along the length of the extrusion. The bore can be capped at the upper end 90a of the extrusion. At the lower end 90b, the bolt housing 70 is fitted within the bore. The bolt housing can be anchored within the bore 91 by conventional fasteners, although welding can be preferred to maintain a smooth contour for the outside of the extrusion 90. In particular, the extrusion has a curved outboard surface 93a (FIG. 12) that provides an aerodynamic drag reduction effect like the extrusion (160) disclosed U.S. Pat. No. 9,873,466, entitled “Drag Reducing Device”, which issued on Jan. 23, 2018, to Applicant, the entire disclosure of which is incorporated herein by reference. The inboard surface 93 can also be curved to reduce the profile of the extrusion and avoid sharp corners. The forward surface 93c is preferably flat to mate flush with a flat face of the rear hinge frame 97, as shown in FIG. 12. It is contemplated that the locking component extrusion 90 can be an extruded aluminum component. As previously noted, the extrusion includes a U-shaped opening 92 through which the bolt handle 61 extends. The bolt housing 70 can be fitted within the bore 91 of the extrusion 90 so that the bolt handle contacts the top end 92a of the opening when the handle is manually pulled upward to release the clamp assembly 50.

As shown best in FIG. 12, the locking component extrusion 90 is attached to the hinge element 95 by fasteners 100, which can be rivets spaced along the length of a rear hinge frame 97 as shown in FIG. 11. The hinge element 95 includes the rear hinge frame 97 and a front hinge frame 96 that each have a length co-extensive with the length of the extrusion 90. The front hinge frame 96 is fixed to the rear frame 25 of the rear sliding frame component 22 to anchor the entire clamp assembly 50 to the rear frame. The two hinge frames 96, 97 include alternating barrel components 98 that receive a hinge pin 99 to form the pivoting hinge feature of the hinge element 95.

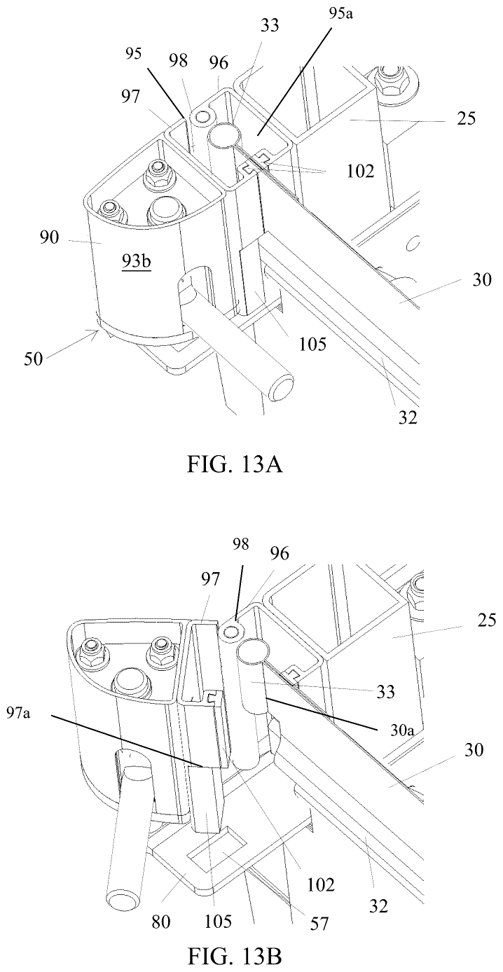

The front and rear hinge frames 96, 97 each define facing T-slots 101, as best shown in FIG. 12. The T-slots receive a seal element 102 that extends along substantially the entire length of the hinge element 95, as shown in FIG. 11. The seal elements 102 can be an elastomeric, rubber or other resiliently compressible material. The seal elements can be compressed into the T-slots or slid vertically into the slots, as depicted in FIG. 11. In some embodiments, the seal elements 102 can include a relatively rigid base with a resiliently compressible pad. The clamping component 51 can further include a roll seal 105 that is fastened to the rear hinge frame 97 in a notch 97a at the bottom of the frame, as best shown in FIG. 13B. The roll seal can include a block of elastomeric, rubber or other resiliently compressible material.

It is contemplated that the clamp assembly 50 has a length that is substantially co-extensive with the vertical dimension of the rear curtain. Thus, the seal elements 102 and roll seal 105 engage substantially the entire side edge of the curtain. In one embodiment, the locking component extrusion 90 and seal elements 102 have a length of about 89.5 inches.

As shown in FIG. 13B, the rear curtain 30 includes a guide bead 33 along the side edge 30a of the curtain. The guide bead 33 can extend along the entire length of the side edge or can be provided at intervals along the length. When the front and rear hinge frames 96, 97 are open, as shown in FIG. 13B, the position of the guide bead is retained by the front hinge frame 96 as the rear curtain 30 is raised. When the front and rear hinge frames 96, 97 are closed, as shown in FIG. 13A, the guide bead 33 is positioned within the hinge cavity 95a. In this closed configuration, the seal elements 102 bear against opposite faces of the curtain 30 to essentially clamp the side edges 30a to the rear frame 25 of the cover system 10. In addition, the roll seal 105 bears against the lateral stiffener 32 at the lower portion of the rear curtain, pressing the stiffener into the forward hinge frame 96. (Alternatively, a second roll seal can be incorporated into the forward hinge frame). The roll seal clamps the lateral stiffener, which essentially clamps the lower portion of the rear curtain since the stiffener is relatively more rigid than the curtain. It is noted that the clamping surface of the roll seal 105 can be configured to generally conform to a curved outer contour of the lateral stiffener 32, which can enhance the grip of the roll seal on the stiffener.

The seal elements 102 on the opposite sides of the curtain and the roll seal 105 on the lower portion of the curtain, together with the attachment of the top edge of the curtain at the top of the rear frame 25, effectively restrain the entire curtain against billowing. The pressure applied by the seals 102, 105 against the curtain 30 and lateral stiffener 32 can be adjusted by adjusting the degree of pivoting of the extrusion 90 and rear hinge frame 97 toward the front hinge frame 96. This adjustment can be accomplished by adjusting the position of the hasp plate 80, which adjust the position of the opening 57 to receive the tip 62 of the post 61 of the bolt element 59. For instance, referring to FIG. 13B, moving the hasp plate 80 to the right will require the rear hinge frame 97 to pivot farther toward the front hinge plate 96 in order for the post 61 to engage the hasp opening 57. This additional movement increases the pressure of the seal elements 102 against the curtain 30 and the pressure of the roll seal 105 against the stiffener 32. Conversely, shifting the hasp plate to the left in FIG. 13B means that the post 61 will engage the hasp opening 57 earlier in the pivoting rotation, so that the seals 102, 105 do not exert as mush force on the curtain and stiffener. One object of the clamping component 51 is to capture the glide bead 33 of the curtain 30. Another object is to restrain the curtain against flapping and billowing. The position of the hasp plate 80 and opening 57 can be adjusted to accomplish these objectives while avoiding accelerated wear on the curtain by excessive force from the seals 102, 105.

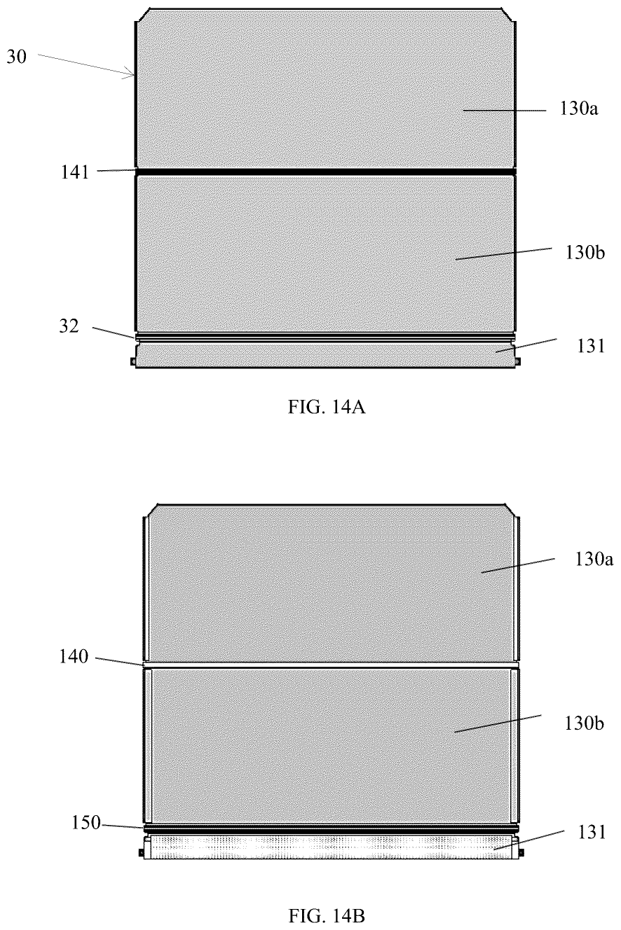

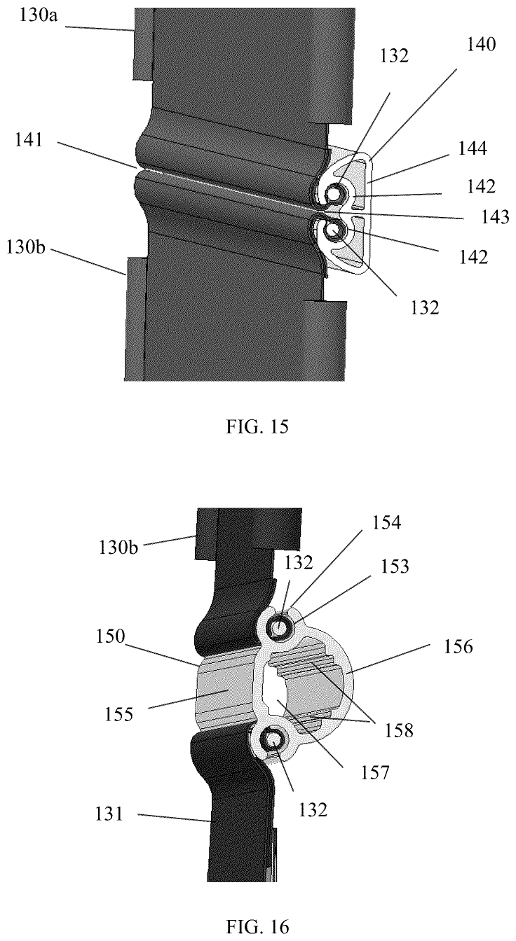

In another feature of the cover system disclosed herein, the rear curtain 30 is a sectionalized curtain in which multiple panels, such as panels 130a, 130b and 131, shown in FIGS. 14A-14B, are connected in a vertical arrangement to form the complete curtain. The horizontal edges of adjacent panels are connected by a lateral keder 140, 150, shown in detail in FIGS. 15 and 16, respectively. In the illustrated embodiment, the upper panel 130a is connected to the lower panel 130b by an intermediate “hidden” keder 140 that is only visible on the interior face of the rear curtain, as shown in FIG. 14B. When viewed from outside the cover assembly, as shown in FIG. 14A, only a horizontal joint 141 between the two curtains is visible. “Hiding” the keder 140 maintains the visual continuity of the rear curtain, particularly when the curtain bears a visual image.

As shown in FIG. 15, the intermediate keder 140 is an extruded body that defines facing channels 142 separated by a slot 143 that extend along the entire length of the keder, co-extensive with the width of the horizontal edges of the two panels 130a, 130b. The two panels include an elongated bead 132 that are seated in a respective one of the channels 142 with the corresponding panel passing through the slot 143. The two channels are connected by a plate 144 to form a hollow extrusion. In a specific embodiment, the keder 140 can be formed of aluminum or a strong, rigid polymer. The intermediate keder 140 can be used to connect any number of panels to form the rear curtain 30. Moreover, the panels can be of different dimensions or heights that can be combined to form rear curtains of different heights.

The rear curtain includes a lower keder 150 that can serve as the lateral stiffener 32 engaged by the roll seal 105 as shown in FIG. 13B. The lower keder 150 is a hollow extrusion, like the keder 140, as shown in FIG. 16. In this embodiment, the lower keder 150 connects a lower panel 130a to a hidden vent panel 141 at the bottom of the rear panel. The keder 150 includes a pair of channels 153 separated by a contact plate 155. The contact plate 155 is arranged to be engaged by the roll seal 105, in the manner described above. The channels 153 include a slot 154 so that the panel, such as panel 130b, can pass through the slot when the elongated bead 132 is seated within the channel 153. Like the keder 140, the keder 150 can connect any adjacent panels to form the complete rear curtain 30.

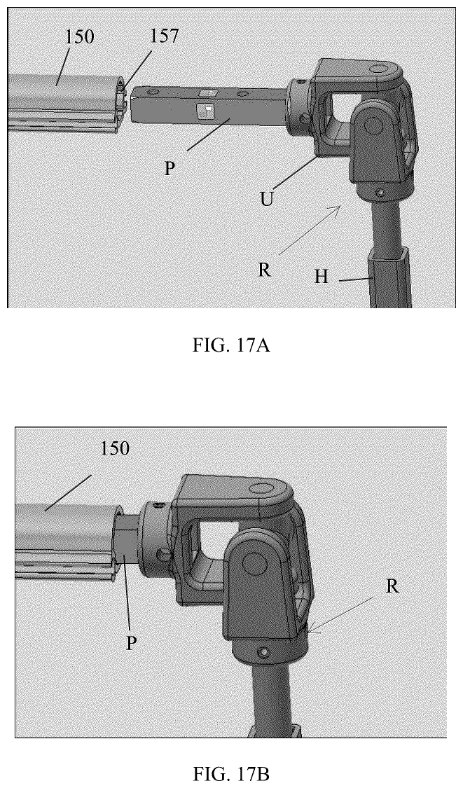

In another feature, the lower keder 150 is configured to engage a roll-up tool R, as shown in FIGS. 17A-17B. The channels 153 of the keder 150 are connected by the contact plate 155 on the outer face of the curtain and by a tubular body 156 on the inner face of the curtain. The body 156 defines an opening 157 along the hollow keder. An arrangement of ridges 158 are defined in the opening along the length of the tubular body 156. The ridges 158 are arranged to be engaged by a rectangular post P of the roll-up tool R. As is known in the art, the post P is connected to a universal joint U so that rotation of the tool handle H of the roll-up tool R produces rotation of the post P. When the post P is fully engaged within the opening 157 of the extruded lower keder 150, the edges of the post engage the ridges 158 inside the opening so that the lower keder 150 rotates with the post. As the keder rotates, the rear curtain 30 is rolled up or unrolled, depending on whether the curtain is extended or retracted.

The present disclosure should be considered as illustrative and not restrictive in character. It is understood that only certain embodiments have been presented and that all changes, modifications and further applications that come within the spirit of the disclosure are desired to be protected. For instance, the bolt assembly 55 disclosed herein is configured for manual operation. Alternatively, the assembly can be configured for remote or non-manual operation, such as by the inclusion of an electrical solenoid configured to raise or raise/lower the vertical post 61. In this instance, the handle 60 can be eliminated or can be retained for manual operation of the clamp assembly upon a failure of the solenoid.

What is claimed is:

1. An improvement for a closure of a cover system mounted on a vehicle or trailer, the closure including a cover system frame defining a rectangular access opening for access therethrough to the vehicle or trailer, and a flexible curtain extendable from the top of the frame to the bottom of the frame and having opposite sides sized to cover the access opening when the curtain is extended to the bottom of the frame, the improvement comprising:
a clamping component extending vertically along at least one side of said curtain, said clamping component including a hinge element having a forward hinge frame fastened to the cover system frame and a rear hinge frame pivotably connected to said forward hinge frame, said forward and rear hinge frames defining a vertical cavity to receive the side of said curtain, and said forward and rear hinge frames including respective seal elements facing each other to clamp onto the side of said curtain when the hinge element is in a closed configuration, said hinge element having an open configuration in which said rear hinge frame is pivoted away from said forward hinge frame and the side of the curtain is not clamped between said seal elements; and
a locking component fastened to said clamping component and including;
an elongated hollow housing fastened to said rear hinge frame;
a bolt assembly at a bottom end of said hollow housing, said bolt assembly including;
a bolt housing having an elongated hollow main body with upper and lower caps at opposite ends of said main body, each cap defining a bore therethrough, and said main body defining a slot between said upper and lower caps;
a bolt including a vertical post and a horizontal post projecting radially outward from said vertical post, said bolt disposed within said bolt housing with;
said vertical post slidably extending through the bore in each of said upper and lower caps with a lower end portion of said vertical post projecting below said lower cap, and
said horizontal post projecting outward from said main body through said slot, wherein said horizontal post is sized to be manually grasped to move said bolt vertically within said main body, and
a biasing spring concentrically mounted on said vertical post between said upper cap and a pin projecting radially from said vertical post between said horizontal post and said upper cap to contain said biasing spring between said pin and said upper cap such that said biasing spring is compressed when said vertical post of said bolt is moved upward toward said upper cap; and
a hasp affixed to said vehicle or said cover system frame at said access opening of said cover system frame, said hasp including a top plate defining an opening configured to receive said lower portion of said vertical post therethrough to lock said clamping component in said closed configuration.

2. The improvement of claim 1, wherein said hasp and said vertical post of said bolt include an angled contact interface so that as the locking component is pivoted with the rear hinge frame of the hinge element from the open configuration of the hinge element to the closed configuration of the hinge element, the vertical post is pushed upward against said biasing spring until the lower end portion of said bolt is aligned with said opening in said hasp plate.

3. The improvement of claim 2, wherein said angled contact interface includes p an angled contact plate of said hasp extending from said top plate and angled downward relative to said elongated hollow housing and arranged to contact said lower end portion of the vertical post of the bolt as the locking component is pivoted with the rear hinge frame of the hinge element from the open configuration of the hinge element to the closed configuration of the hinge element.

4. The improvement of claim 3, wherein said lower end portion of said vertical post of the bolt includes a rounded tip for engaging said angled contact plate of said hasp.

5. The improvement of claim 1, wherein said opening in said top plate has a linear edge and said lower end portion of said bolt includes a flat vertical surface arranged to bear against said linear edge when the vertical post extends through said opening.

6. The improvement of claim 1, wherein each of said upper and lower cap includes a bushing disposed within the corresponding bore of each cap, said bushing sized to slidably receive said vertical post therethrough.

7. The improvement of claim 1, wherein said horizontal post projects outward from said slot of said housing a sufficient distance to be manually grasped to manually move the vertical post of said bolt upward against said biasing spring.

8. The improvement of claim 1, wherein said seal elements are formed of a resiliently compressible material.

9. The improvement of claim 1, wherein:
each of said forward and rear hinge frames define a T-slot extending along a length thereof; and
each respective seal element is configured to be mounted within a respective T-slot.

10. The improvement of claim 1, in which said flexible curtain includes a lateral stiffener extending across a lower portion of said curtain, wherein:
said clamping component includes a resiliently compressible seal mounted to said rear hinge frame to bear against said lateral stiffener when said clamping component is in said closed configuration.

11. The improvement of claim 1, in which said flexible curtain includes a side bead on said at least one side of said curtain, wherein:
said vertical cavity is sized to receive said side bead when the clamping component is in said closed configuration.

12. The improvement of claim 1, comprising a clamping component and a locking component for each of said opposite sides of said flexible curtain.

13. The improvement of claim 1, wherein said elongated hollow housing of said locking component is an aluminum extrusion.

14. The improvement for a flexible rear curtain for a closure of a cover system mounted on a vehicle or trailer, the closure including a cover system frame defining a rectangular access opening for access therethrough to the vehicle or trailer, the flexible curtain extendable from the top of the frame to the bottom of the frame and having opposite sides sized to cover the access opening when the curtain is extended to the bottom of the frame, the improvement comprising:
a plurality of panels that, when connected in a vertical arrangement, form the flexible curtain, each panel having opposite top and bottom horizontal edges, wherein adjacent top and bottom edges of adjacent ones of the plurality of panels include an elongated bead along the corresponding edge; and
a number of keders including an extruded hollow body having a length corresponding to the horizontal width of each of said plurality of panels, each keder defining a pair of slotted channels extending along the length of said keder and configured to receive the elongated bead of a corresponding one of the adjacent ones of the plurality of panels, thereby connecting the panels in said vertical arrangement.

15. The improvement of claim 14 in which the cover system has a clamping component extending vertically along at least one side of the rear curtain that includes a roll seal at a lower end thereof, wherein:
said number of keders includes a lower keder in which said pair of slotted channels is separated by a contact plate extending along the length of the keder, and
said contact plate arranged to be engaged by the roll seal of the clamping component when the rear curtain is extended to the bottom of the frame.

16. The improvement of claim 14, wherein said number of keders includes a lower keder connecting a lowermost pair of panels, said lower keder including a tubular body defining an opening along the length of the keder, the opening defining an arrangement of ridges configured to engage the rectangular post of a roll-up tool.

17. The improvement of claim 14, wherein said number of keders includes an intermediate keder in which said pair of slotted channels communicate with a common slot.

18. The improvement of claim 17, wherein said number of keders includes a lower keder connecting a lowermost pair of panels, said lower keder including a tubular body defining an opening along the length of the keder, the opening defining an arrangement of ridges configured to engage the rectangular post of a roll-up tool.
